(19) United States
(12) Patent Application Publication
(10) Pub. No.: US 2006/0133959 A1
(43) Pub. Date: Jun. 22, 2006

(54) Luminometer for simultaneously detecting multiple samples

(75) Inventors: Jiann-Hua Wang, Taipei (TW); Tsung-Kai Chuang, Tainan City (TW); Tzu-Chiang Wu, Miaoli City (TW); Chien-Ho Chuang, Kaohsiung (TW)

Correspondence Address: BIRCH STEWART KOLASCH & BIRCH, PO BOX 747, FALLS CHURCH, VA, 22040-0747, US

(73) Assignee: Kaiwood Technology Co., Ltd.

(21) Appl. No.: 11/155,584

(22) Filed: Jun. 20, 2005

(30) Foreign Application Priority Data
Dec. 21, 2004 (TW) 093139899

(51) Int. Cl. G01N 21/64

(52) U.S. Cl. 422/82.08

(57) ABSTRACT

A luminometer includes a movable carrier carrying a number of luminescence collectors arranged in an array for simultaneously detecting the same number of samples received in multiple wells defined in a microplate. An optic fiber optically couples each luminescence detector to an associated charge-coupled device whereby a luminescence signal emitted from each sample is transmitted to the charge-coupled device and converted thereby into a corresponding electric signal. The charge-coupled devices are isolated from each other by partitions, which eliminate undesired interference among the luminescence signals transmitted to the charge-coupled device. A driving unit is provided to move the carrier between rows of the wells defined in the microplate.

### BACKGROUND OF THE INVENTION

1. Field of the Invention

The present invention relates to a luminometer, and more particularly to a luminometer featuring simultaneous detection of multiple samples and thus effecting reduction of time for detection.

2. Description of Related Art

Luminescence has been widely used as an indicator in a lab for identifying bio-reactions. The advantages of luminescence technology include no exciting light source required, no radioactive material needed, and low costs of instruments. Two types of luminometer are known, namely tube luminometer and microplate luminometer. The tube luminometer can process one single tube each time and is difficult to analyze various samples simultaneously, while the microplate luminometer can process signals from multi wells and is thus suitable for screening and analysis of various samples at the same time.

FIG. 1 of the attached drawings shows a conventional microplate luminometer, which comprises a detecting section 10 having a testing end 11 movably received in the detecting section 10 and facing a microplate 20 in which a plurality of wells 21 is defined. The testing end 11 is positionable on each well 21 with an opening 12 of the testing end 11 opposing the well 21 whereby luminescence 15 generated in and emitted from the well 21 transmits through the opening 12 and into the testing end 11. Arranged inside the detecting end 11 is a lens 13 through which the luminescence 15 transmits. The lens 13 focuses the luminescence 15 on a reflector 14, such as a prism, which re-directs the luminescence 15 to a photomultiplier tube (PMT) 16. The PMT 16 converts the luminescence 15 into a corresponding electric signal for subsequent processing.

The conventional luminometer has only one detecting end 11. The detecting end 11 must be sequentially positioned on each well of the microplate by movement along the X-axis and the Y-axis. This is very time-consuming and this is even worse for processing a large number of samples. In addition, mechanical devices and mechanisms for precisely moving the detecting end among the wells of the microplate are expensive, which adds the installation costs of the luminometer.

The conventional luminometer also suffers the time lag in moving the detecting end from one well to the next well. This is particularly true when the time of luminescence reaction inside the wells is shorter than the time lag of movement of the detecting end, and as a consequence thereof, significant error may result. Another drawback of the conventional luminometer is imprecise positioning of the detecting end caused by thermal effect induced by frequent movement of the detecting end.

### SUMMARY OF THE INVENTION

Thus, a primary objective of the present invention is to provide a luminometer comprising an array of detectors, which allows for simultaneous detection of a number of samples, whereby processing efficiency and accuracy of sample detection can be enhanced, and the test condition can be substantially maintained the same for all the samples.

In order to accomplish the aforementioned objective, in accordance with the present invention, a luminometer is provided, comprising a movable carrier carrying a plurality of luminescence detectors arranged in a linear array for simultaneously detecting a number of samples received in multiple wells defined in a microplate. An optic fiber optically couples each luminescence detector to an associated charge-coupled device whereby a luminescence signal emitted from each sample is transmitted to the charge-coupled device and converted thereby into a corresponding electric signal. The charge-coupled devices are isolated from each other by partitions, which eliminate undesired interference among the luminescence signals transmitted to the charge-coupled device.

The charge-coupled device can be replaced by other devices of the same function, such as a complementary metal-oxide semiconductor (CMOS) device and an avalanche photo-diode.

A driving unit is further included, for moving the carrier between rows of the wells defined in the microplate. The driving unit may comprise a linear rail along which the carrier moves.

Preferably, a lens is arranged in each luminescence detector to couple the luminescence signal to the optic fiber.

The charge-coupled devices are preferably arranged in an array. Partitions are provided between adjacent charge-coupled devices to eliminate undesired interference between the luminescence signals transmitted to the charge-coupled devices.

Other objects, advantages, and novel features of the invention will become more apparent from the following detailed description when taken in conjunction with the accompanying drawings, in which:

### BRIEF DESCRIPTION OF THE DRAWINGS

FIG. 1 is a schematic cross-sectional view of a conventional luminometer, and a microplate supporting samples to be detected by the luminometer;

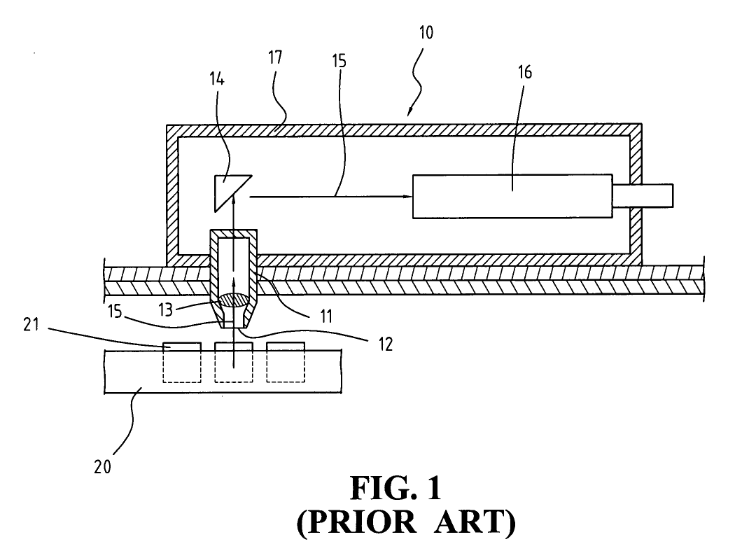

FIG. 2 is a schematic cross-sectional view showing a luminometer constructed in accordance with the present invention;

FIG. 3 is a perspective view of an optic-to-electric converter of the luminometer of the present invention; and

FIG. 4 is a perspective view of the luminometer of the present invention that is employed to detect multiple samples received in wells arranged in a matrix on a microplate.

### DETAILED DESCRIPTION OF PREFERRED EMBODIMENT

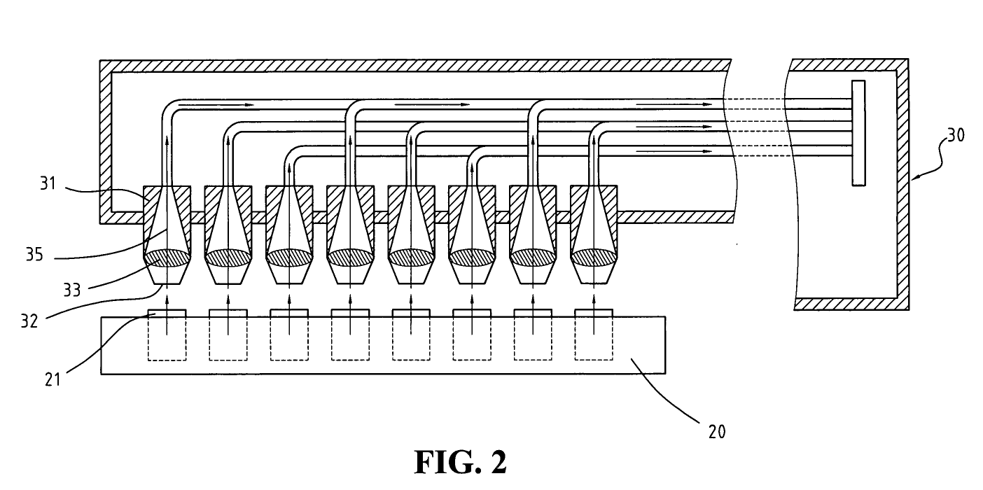

With reference to the drawings and in particular to FIG. 2, a luminometer constructed in accordance with the present invention comprises at least one movable carrier 30 carrying an array of luminescence collectors 31 that receive luminescence signals 35 and transmits the luminescence signals 35 through corresponding optic fiber 34 to a detector 36 that converts the luminescence signals 35 into corresponding electrical signals for subsequent processing.

In the embodiment illustrated, the luminometer is employed to process samples retained in a microplate 20, which may comprises for example 96 wells 21 that are arranged in an 8×12 array. In other words, there are 12 rows of wells and each row contains eight wells. That means at most 96 samples can be held by the microplate 20. The carrier 30 may carry for example an array of single row of eight collectors 31, arranged in position to correspond to the eight wells of each row of the microplate 20 whereby when the carrier 30 is moved to a position corresponding to one row of the microplate 20, the eight wells 21 of the row can be processed simultaneously.

Each collector 31 defines an entry opening 32 through which the luminescence signal 35 emitted from the corresponding well 21 of the microplate 20 enters the collector 31. Arranged inside each collector 31 has a lens 33, which couples the luminescence signal 35 into the corresponding optic fiber 34 that is connected to the collector 31. The luminescence signal 35 transmits along the optic fiber 34 to the optic-to-electric converter 36 by which the luminescence signal 35 is converted into a corresponding electrical signal for subsequent processing, which will not be further described for it does not constitute any novel part of the present invention.

Each collector 31 is connected to the detector 36 by an optic fiber 34. The optic fibers and the optic-to-electric converter 36 are preferably housed in a case 37 (not shown) for purposes of light shielding and protection. The optic fibers 34 can be configured in any desired shape and length to suit for the design of the device. The optic fibers 34 completely transmit the luminescence signals to the detector 36. However, errors caused by environmental lights around the microplate 20 may occur. Thus, it is preferred that the luminometer is operated in a dark environment to eliminates the error caused by surrounding light. A solution to such a problem is to add an outer casing enclosing the microplate 20. All experiments must be done in a dark space.

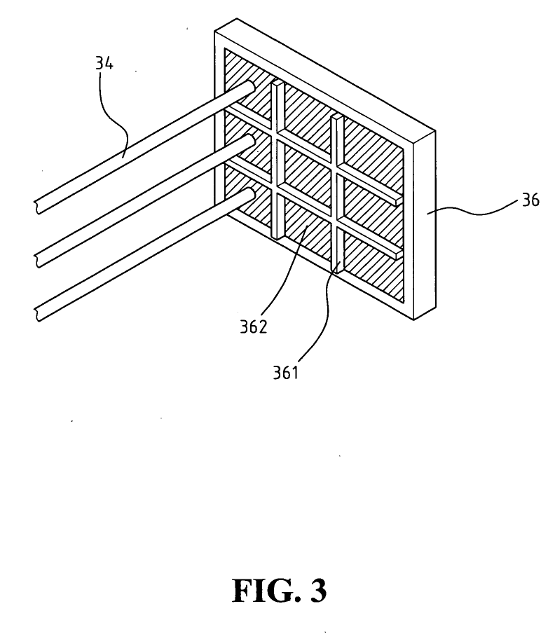

Also referring to FIG. 3, the detector 36 comprises an array of optic sensing elements 362, such as charge-coupled devices (CCDs), complementary metal-oxide semiconductor (CMOS) device, and avalanche photo-diode, each corresponding to and receiving luminescence signal from each optic fiber 34, whereby the luminescence signal of each collector 31 is independently converted into associated electric signal by respective optic sensing element 362. The optic sensing elements 362 can be arranged in array of any forms, such as 3×3 matrix as shown in FIG. 3. Alternatively, a linear array comprised of nine optic sensing elements 362 can be employed. Partitions or barrier plates 361 are provided between adjacent optic sensing elements 362 to eliminate undesired interference between adjacent optic sensing elements 362. The electric signals generated by the optic sensing elements 362 can be transmitted to an optional processing unit (not shown), which converts the electric signal that are originally analog into digital data for subsequent processing.

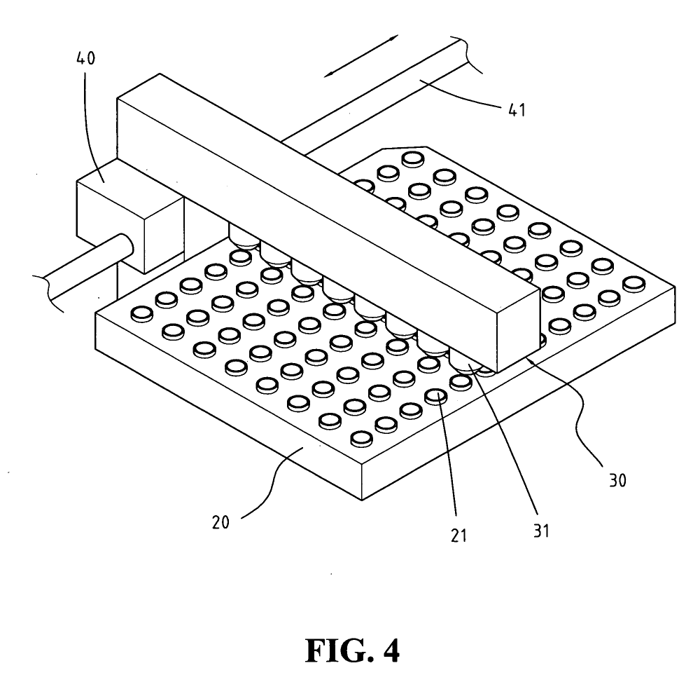

Also referring to FIG. 4, the luminometer comprises a driving unit 40 that linearly moves the carrier 30, and thus the collectors 31 mounted on the carrier 30, along a rail 41, whereby the collectors 31 can be selectively positioned on each row of wells 21 of the microplate 20. In other words, the carrier 30 is moved from one row of wells 21 to the next row in a row-by-row manner until all the 12 rows of the wells 21 are completely scanned by the collectors 31. Each time the carrier 30 stops on each row, the eight wells 21 of row are detected simultaneously by the eight detectors 31 of the carrier 30. Apparently, the processing efficiency is increased by eight times for eight wells are processed at the same time. An additional benefit is that each well can be detected for more than once at the time interval when the carrier 30 stops on the well for the carrier 30 may stay on the same well for eight times of the time that the conventional luminometer may do. As a result, more than one set of data can be obtained for each sample in each detection operation.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A luminometer comprising:
a carrier carrying a plurality of luminescence collectors each adapted to collect a luminescence signal from a sample;
an optical transmission member optically coupled to each luminescence collector to receive the luminescence signal; and
a detector comprising a plurality of optic sensing elements respectively coupled to the optic transmission member to receive the luminescence signal and provide, in response thereto, a second signal of different form for the luminescence signal.

2. The luminometer as claimed in claim 1, wherein each luminescence collector comprises a lens for coupling the luminescence signal to the optic transmission member.

3. The luminometer as claimed in claim 1, wherein the transmission member comprises an optical fiber extending from each luminescence collector to the optic sensing element.

4. The luminometer as claimed in claim 1, wherein the optic sensing element comprises a charge-coupled device.

5. The luminometer as claimed in claim 1, wherein the optic sensing element comprises a complementary metal-oxide semiconductor device.

6. The luminometer as claimed in claim 1, wherein the optic sensing element comprises an avalanche photo-diode.

7. The luminometer as claimed in claim 1, wherein the plurality of luminescence collectors are arranged in a linear array adapted to simultaneously collect luminescence signals from samples arranged in the same linear array.

8. The luminometer as claimed in claim 1, wherein a partition is arranged between adjacent optic sensing elements to reduce interference between the luminescence signals received by the optic sensing elements.

9. The luminometer as claimed in claim 1 further comprising a driving unit to cause linear movement of the carrier.

10. The luminometer as claimed in claim 9, wherein the driving unit comprises a linear rail along which the carrier moves.

11. The luminometer as claimed in claim 1, wherein the detector comprises means for converting the luminescence signal into an analog electric signal.

12. The luminometer as claimed in claim 11, wherein the signal converter comprises means for converting the analog signal into digital signal.
